(19) United States
(12) Patent Application Publication
(10) Pub. No.: US 2009/0163229 A1
(43) Pub. Date: Jun. 25, 2009

(54) Indicators for Dual-Mode Phones

(75) Inventors: Rajneesh Bajpai, San Jose, CA (US); Ramesh Kondru, Secunderabad (IN); Saji Xavier, Indiranagar (IN)

Correspondence Address: BLAKELY SOKOLOFF TAYLOR & ZAFMAN LLP, 1279 OAKMEAD PARKWAY, SUNNYVALE, CA, 94085-4040, US

(73) Assignee: ARUBA NETWORKS, INC., Sunnyvale, CA (US)

(21) Appl. No.: 11/963,275

(22) Filed: Dec. 21, 2007

(51) Int. Cl. H04Q 7/20

(52) U.S. Cl. 455/466

(57) ABSTRACT

Indicator control for dual-mode phones. While under control of an enterprise Wi-Fi network, indicators on a dual-mode phone can be controlled using SIP messages. When operating in cellular mode, indicators on the dual-mode phone are controlled by SMS messages which are intercepted on arrival. A software agent connected to the enterprise SIP PBX and voicemail system receives messages for example indicating voicemail status which cause the software agent to send specially formatted SMS messages to the cellular phone and operate indicators.

### CROSS REFERENCE TO RELATED APPLICATIONS

The present application is related to (1) U.S. patent application Ser. No. 11/955,104 filed on Dec. 12, 2007 and entitled “Single Number Presentation for Dual-Mode Phones” (Attorney docket no. 6259P041); (2) U.S. patent application Ser. No. 11/955,108 filed Dec. 12, 2007 and entitled “Delayed ACK in Dual-Mode Call Handover” (Attorney docket no. 6259P040); and (3) U.S. patent application Ser. No. 11/955,091 filed Dec. 12, 2007 and entitled “Single Voicemail for Dual-Mode Phones” (Attorney docket no. 6250P042), all incorporated herein by reference.

### BACKGROUND OF THE INVENTION

The present invention relates to the operation of dual-mode phones, and more particularly, to handling indicators in dual-mode phones.

Dual-mode phones support connections via Wi-Fi and cellular networks. While associated with the enterprise Wi-Fi network, the user places and receives calls through the enterprise Wi-Fi system. While out of range of the enterprise Wi-Fi network, the user places and receives calls through the cellular system.

A problem arises however, as the enterprise provides a voicemail system to enterprise users, and the cellular system provides an additional voicemail system to its users. When in the range of the enterprise Wi-Fi system, the dual-mode phone user can receive indications of voicemail/fax/text through SIP Wi-Fi signaling to the dual-mode phone. But when connected to the cellular network, this signaling is not available.

What is needed is a method of controlling the indicators in a dual-mode phone through the cellular network.

### BRIEF DESCRIPTION OF THE DRAWINGS

The invention may be best understood by referring to the following description and accompanying drawings that are used to illustrate embodiments of the invention in which:

FIG. 1 shows a dual-mode phone in a network, and

FIG. 2 shows a dual-mode phone.

### DETAILED DESCRIPTION

Embodiments of the invention relate to dual-mode phones, and to controlling indicators in dual-mode phones. In an embodiment of the invention, a dual-mode phone when operating in its cellular mode recognizes and interprets SMS messages to control indicators on the dual-mode phone. These SMS messages may be removed from the SMS log after processing. In the case of enterprise voicemail systems, a SIP back to back user agent (B2BUA) running in the enterprise environment subscribes to Message-Wait events generated by the PBX. When a message is left for the dual-mode phone user in the enterprise, the SIP PBX signals the agent, which generates and sends the proper SMS message to the cellular side of the dual-mode phone when it is outside of enterprise Wi-Fi range.

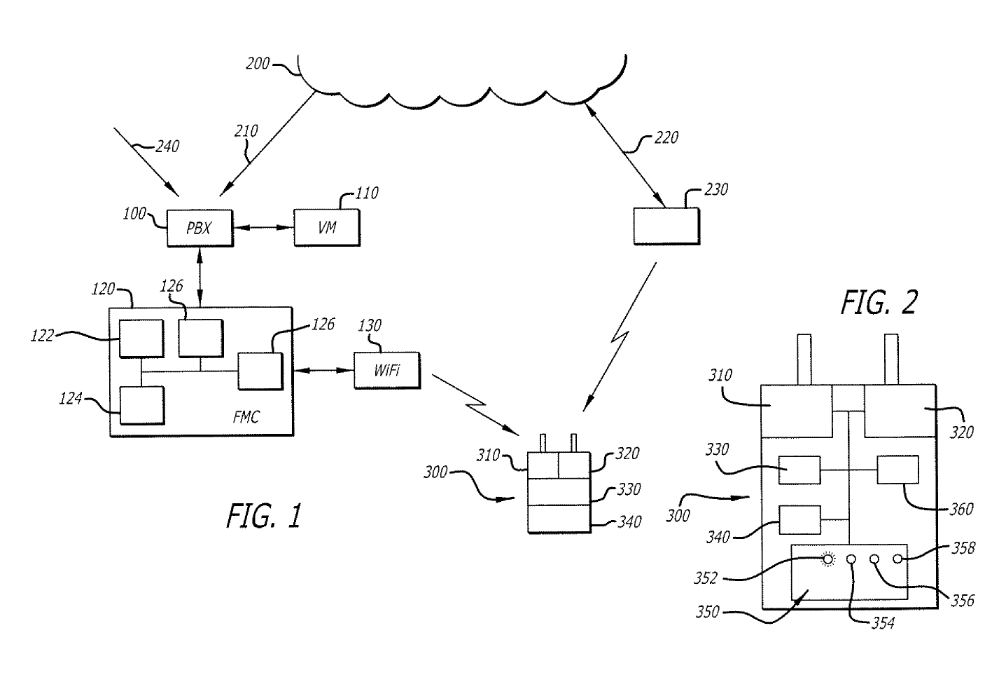

FIG. 1. shows an embodiment of the invention including a dual-mode phone. Enterprise SIP PBX communicates 210 with public switched telephone network (PSTN) 200. SIP PBX 100 also supports voicemail system 110. SIP PBX 100 also communicates with fixed mobility controller (FMC) 120. Mobility controller 120 bridges the worlds of SIP PBX 100 and Wi-Fi network controller 130. SIP PBX 100 and fixed mobility controller 120 communicate for example using protocols established by RFC 3261, RFC 2833, and RFC 3631, incorporated herein by reference. Voice streams are typically encoded using the RTP protocols defined by RFC 3550, incorporated herein by reference.

As understood in the art, such a hardware platform as shown in FIG. 1 for hosting mobility controller 120 includes a central processing unit (CPU) 122 connected to memory hierarchy 124, and to one or more interfaces 126. In one embodiment, CPU 122 is a MIPS-style CPU such as those from Raza Microelectronics or Cavium Networks, although CPUs from other companies such as Intel, AMD, Freescale, or the like may also be used. Memory hierarchy 124 includes read-only memory for system initialization, high-speed read-write memory such as DRAM, and bulk memory such as a hard disk or compact flash storage for files. Interfaces 126 include wired and wireless Ethernet interfaces as are known to the art. Controller 120 typically operates under the control of an operating system such as Linux, hosting software processes which provide device functionality. Additional hardware may be provided to provide for high-speed packet handling, crypto processing, and the like. While FIG. 1 shows mobility controller 120 and Wi-Fi-network controller 130 as separate entities, it should be noted that they may also be software processes running on a shared hardware platform. As an example, a single hardware platform based on a multi-core MIPS processor such as those from Raza Microelectronics or Cavium Networks could host the functions of Wi-Fi network controller 130 along with mobility controller 120 and additional functions such as intrusion detection and/or firewalls.

Dual-mode phone 300 has first radio subsystem 310 for Wi-Fi communications such as to Wi-Fi network controller 130. Dual-mode phone 300 also has second radio subsystem 320 for communicating with cellular network 230 and through public switched telephone network 200. As is common with many such devices, dual-mode phone 300 is a digital device operating under control of CPU 330 through programs and data stored in memory hierarchy 340. Dual-mode phone 300 also has display 350 with indicators 352, 354, 356. In one embodiment, display 350 is a liquid crystal display. Indicators 352, 354, 356 may be separate display elements such as light emitting diodes, or they may be fixed designs on liquid crystal display 350, or may be areas on display 350 in which different symbols may be displayed such as by providing different bitmaps representing the symbol to be displayed as an indicator. Other aspects of dual-mode phone 300 such as speakers, microphones, power, keyboards and the like are understood by those in the art, and are not shown.

In operation, when dual-mode phone 300 is in the range of enterprise Wi-Fi network controller 130, indicators 352, 354, 356 may be controlled by SIP signaling over the Wi-Fi network as described in RFC 3842, incorporated herein by reference. As an example, mobility controller 120 contains a back to back user agent (B2BUA) software process which subscribes to message wait events produced by SIP PBX 100. Messages from PBX 100 and voicemail system 110 may be communicated as SIP messages through network controller 130 to alert the user of events of interest, such as waiting voicemail, text messages, emails, or the like. Such SIP messages are transmitted over the Wi-Fi network to a user agent process operating in dual-mode phone 300, and can activate and/or deactivate indicators 352, 354, 356.

Such indicators 352, 354, 356 in dual-mode phone 300 can also be used to indicate other conditions such as the presence of text or e-mail messages, or other conditions.

According to an embodiment of the invention, when dual-mode phone 300 is not within the range of the enterprise Wi-Fi network, mobility controller 120 cannot use SIP or SIP-style messaging. Instead, mobility controller 120 produces a SMS message which is sent through SIP PBX 100 over public switched telephone network 200 to the cellular number associated with dual-mode phone 300. In an alternate embodiment, e-mail messages may be used.

When the SMS message is received through radio subsystem 320 by dual-mode phone 300, agent 360 recognizes the SMS message, and takes appropriate action with respect to indicators 352, 354, 356.

Agent 360 on recognizing the SMS message may remove the SMS message from the queue after taking the appropriate action with respect to indicators 352, 354, 356. In such an embodiment, the user of dual-mode phone 300 will not see such SMS messages.

Appropriate SMS messages for agent 360 may be recognized by the message header, or by message contents, One SMS message may alter a single indicator, or multiple indicators. An SMS message may indicate that a fixed indicator is to be turned on, turned off, or flashed. In some embodiments, an SMS message may include data such as a bitmapped image for an icon to be displayed on screen 350.

SMS messages for agent 360 may be authenticated, for example to reduce transmission errors and/or spoofing. Such authentication may be accomplished, for example, by verifying the sender of the SMS message for agent 360 against one or more authorized senders. SMS messages for agent 360 may be authenticated using check digits, checksums, or digital signatures

While the invention has been described in terms of various embodiments, the invention should not be limited to only those embodiments described, but can be practiced with modification and alteration within the spirit and scope of the appended claims. The description is this to be regarded as illustrative rather than limiting.

What is claimed is:

1. A method of operating an indicator in a dual-mode phone having a first Wi-Fi side and a second cellular side comprising:
generating, at a controller, a SMS message to operate an indicator on a target dual-mode phone,
sending the SMS message through the cellular network to the cellular side of the target dual-mode phone,
receiving, on the cellular side of the target dual-mode phone, the SMS message,
recognizing the SMS message on the target dual-mode phone, and
operating the desired indicator on the target dual-mode phone.

2. The method of claim 1 where the SMS message is removed from the message queue on the target dual-mode phone once it is recognized.

3. The method of claim 1 where the step of recognizing the SMS message on the target dual-mode phone further comprises authenticating the SMS message.

4. The method of claim 3 where the SMS message is authenticated by comparing the sender of the SMS message against a list of one or more authorized senders.

5. The method of claim 3 where the SMS message is authenticated by verifying an authentication code in the SMS message.

6. The method of claim 1 where the SMS message operates on a single indicator.

7. The method of claim 1 where the SMS message operates on more than one indicator.

8. The method of claim 1 where the SMS message contains pattern data to be displayed as the indicator.

9. The method of claim 1 where the SMS message is generated by the controller in response to a voicemail message event signaled by a voicemail system.

10. The method of claim 9 where the SMS message operates an indicator on the dual-mode phone to indicate that one or more voicemail messages are waiting.

11. The method of claim 9 where the SMS messages operates an indicator on the dual-mode phone to indicate that no voicemail messages are waiting.
